(19) United States
(12) Patent Application Publication
(10) Pub. No.: US 2013/0009601 A1
(43) Pub. Date: Jan. 10, 2013

(54) BALANCING ELECTRICAL VOLTAGES OF ELECTRICAL ACCUMULATOR UNITS

(76) Inventor: Stefan Butzmann, Beilstein (DE)

(21) Appl. No.: 13/509,157

(22) PCT Filed: Nov. 19, 2009
(86) PCT No.: PCT/EP2009/065475

§ 371 Date: Sep. 24, 2012

(51) Int. Cl. H02J 7/00

(52) U.S. Cl. 320/118

(57) ABSTRACT

A method for balancing the electrical voltages of at least two electrical accumulator units that are connected in series provides that a coil is charged by a first accumulator unit and a second accumulator unit is charged with the energy of the charged coil. Optionally, only the second accumulator unit is charged. In addition, a corresponding electrical accumulator is provided.

The invention relates to a method for balancing the electrical voltages of at least two serially connected electrical accumulator units. The invention also relates to a corresponding electrical accumulator.

### PRIOR ART

It is clear that in future, in both stationary applications, such as wind farms and non-stationary applications, such as in vehicles, for example hybrid and electric vehicles, new battery systems of which very stringent demands for reliability will be made will increasingly come into use. The background of these demands is that a failure of the battery systems can lead to either a failure of an entire system pertaining to the application, or to a safety-relevant problem. One conceivable example of such a failure is an electric vehicle that if its traction battery fails is “dead in the water”, since it is no longer capable of propelling itself. As an example of a safety-relevant problem, a wind farm is conceivable, in which electrical accumulators are used for protecting the farm against impermissible modes of operation by adjusting the rotor blades under strong wind conditions. Failure of these electrical accumulators can then lead to safety-relevant problems.

When many individual accumulator units, such as battery cells, connected in series are used, the individual accumulator units are not automatically equal. As a result, particularly over the service life of the accumulator units, this leads to unequal electrical voltages among the individual accumulator units, unless appropriate countermeasures are taken. Especially with lithium-ion batteries, excessive charging or deep discharging of individual accumulator units leads to irreversible damage. Such excessive charging or deep discharging can result when a battery management system regulates a charging or discharging operation based on one of the accumulator units, which is not representative all of the accumulator units. For that reason, balancing of the electrical voltages of the electrical accumulator units among one another must be done at regular intervals. This balancing is known as “cell balancing”. To that end, the individual accumulator units are discharged, by external wiring provisions, in such a way that after the balancing, they all have the same electrical voltage.

It is known for that purpose to perform so-called resistance balancing. To that end, an ohmic resistor or a resistor combination is assigned to each accumulator unit via switches. By means of the resistors, the accumulator units are discharged until such time as the accumulator units have the electrical voltage. It is disadvantageous here that energy stored in the electrical accumulator units is converted into heat by the resistors and is carried away unused, for the sake of achieving the desired charge balance. Hence there is a need for a way in which balancing the electrical voltages of a plurality of accumulator units among one another is attained with little energy loss and in which a substantial improvement in the efficiency of a complete electrical accumulator system is brought about.

### SUMMARY OF THE INVENTION

According to the invention, it is provided that by means of the one accumulator unit, a coil is charged, and that with the energy of the charged coil, the other accumulator unit is charged, and selectively only the other accumulator unit is charged. This means that if there are more than two accumulator units, a plurality of other accumulator units or all the other accumulator units can be charged from the coil of one of the other accumulator units. In this way, it becomes possible for the energy stored in the accumulator units not to be merely converted into heat, but to be transferred from the one accumulator unit to the other, so that the electrical voltages of the various accumulator units are balanced with each other. Charging a coil is understood to mean that the coil is excited. Charging the other accumulator unit should be understood to mean that the coil is excited, and by means of the electrical energy that is thus available, the other accumulator unit is further charged. Charging should accordingly be understood to mean not full charging of the entire electrical accumulator, but rather transporting an electrical charge between the accumulator units and the coil for the sake of balancing the electrical voltages.

In a further feature of the invention, it is provided that the two accumulator units are located adjacent one another. Being located adjacent one another should be understood to mean that the accumulator units are connected directly in series with one another, and a positive pole of one of the accumulator units is connected directly to a negative pole of the other accumulator unit via a line.

In a further feature of the invention, it is provided that the coil is charged by means of the accumulator unit having the higher voltage. As a result, an approximation of the voltages of one accumulator unit and the other accumulator unit to one another can be attained.

In a further feature of the invention, it is provided that as the accumulator units, one accumulator cell each, in particular a battery cell, is used.

In a further feature of the invention, it is provided that the coil is charged by closure of at least one switch. Using the switch makes it possible to charge at least one coil in a targeted manner. In this way, the method can be employed in a targeted manner to individual accumulator units, without always having to include all the accumulator units in the method.

In a further feature of the invention, it is provided that the coil charges the other accumulator unit by opening the switch. By appropriate interconnection, it becomes possible to end the charging of the coil by opening the switch, and by reinduction, or in other words de-excitation, the coil makes the energy stored in it available. In that case, the coil outputs the stored electrical energy, and that energy is taken up by the other accumulator unit, which is being charged. The combination here of closing the switch to charge the coil and opening the switch to charge the accumulator unit is advantageous, since by means of only two positions of the switch, both the charging of the coil and the charging of the accumulator unit can be brought about in succession in a simple way.

In a further feature of the invention, it is provided that the other accumulator unit is charged by the coil via at least one diode. This is especially advantageous whenever a flow of current, which flows into the coil upon charging, is reversed and flows out of the coil again, for charging the accumulator unit in the reverse manner. Thus the coil is automatically connected to the accumulator units to be charged, and the charging of the other accumulator unit depends on whether the coil is being charged or not and whether the assigned switch is actuated.

In a further feature of the invention, it is provided that a plurality of charged accumulator units and a plurality of switches are used, and that the charged coil, by means of an opening of at least one switch, charges at least one accumulator unit assigned to the switch. The association of switches with individual accumulator units makes it possible in a simple way in terms of circuitry, beginning with one accumulator unit, to balance that accumulator unit with one or more other accumulator units. This can be done in particular in the form of a chain, so that two accumulator units, one at the beginning and one at the end of the chain, can each charge only one adjacent accumulator unit via one coil, and all the other accumulator units can each selectively charge one or two adjacent accumulator units.

The invention relates further to an electrical accumulator having at least two serially connected electrical accumulator units and one electrical balancing circuit, in particular for performing the method described above, in which the balancing circuit has at least one coil for being charged by the accumulator unit and for charging the other accumulator units, and selectively only the other accumulator unit can be charged.

In a further feature of the invention, it is provided that the balancing circuit has at least one diode and/or at least one switch.

In a further feature of the invention, it is provided that the switch is embodied as a semiconductor switch, in particular a transistor, thyristor, or the like. By the use of semiconductor elements, very easy automation is made possible, by means of electrical components, such as circuits. Moreover, in this way the device of the invention can be embodied in a space-saving way and can be produced economically.

In a further feature of the invention, it is provided that each of the accumulator units has an accumulator cell, in particular a battery cell.

The drawings illustrate the invention in terms of an exemplary embodiment; in the drawings:

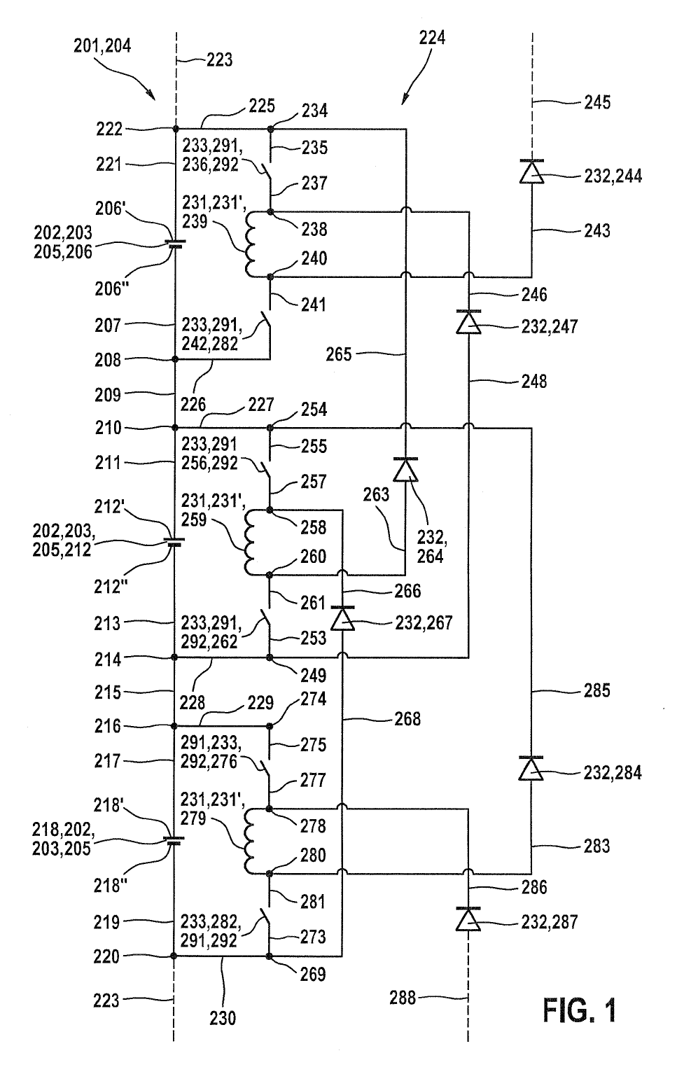

FIG. 1 shows an electric switch with a balancing circuit;

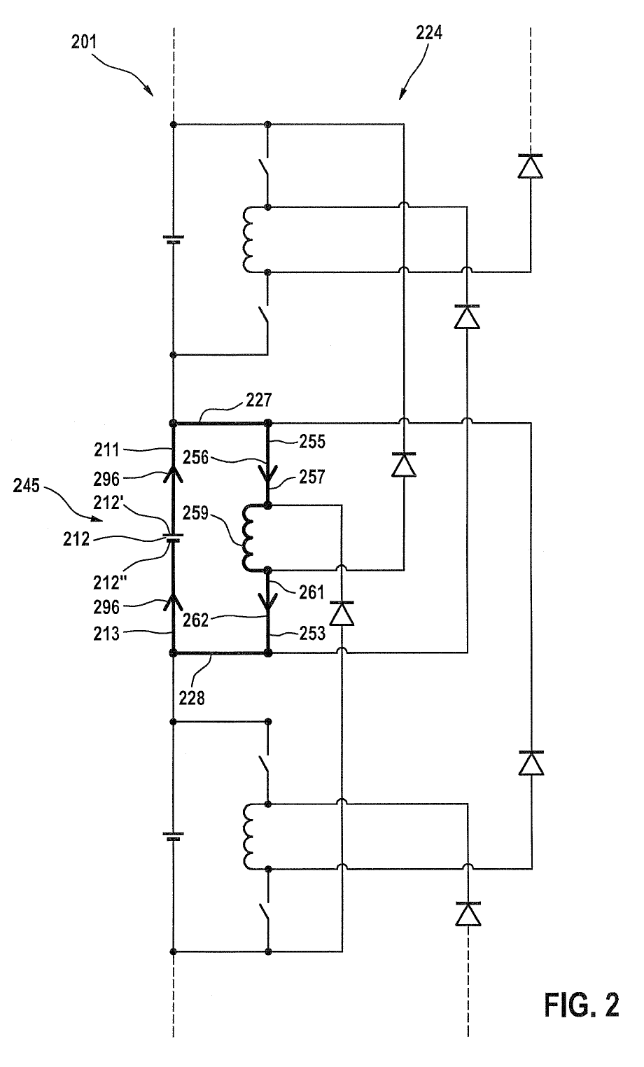

FIG. 2 shows the accumulator with the balancing circuit of FIG. 1 in a first method step;

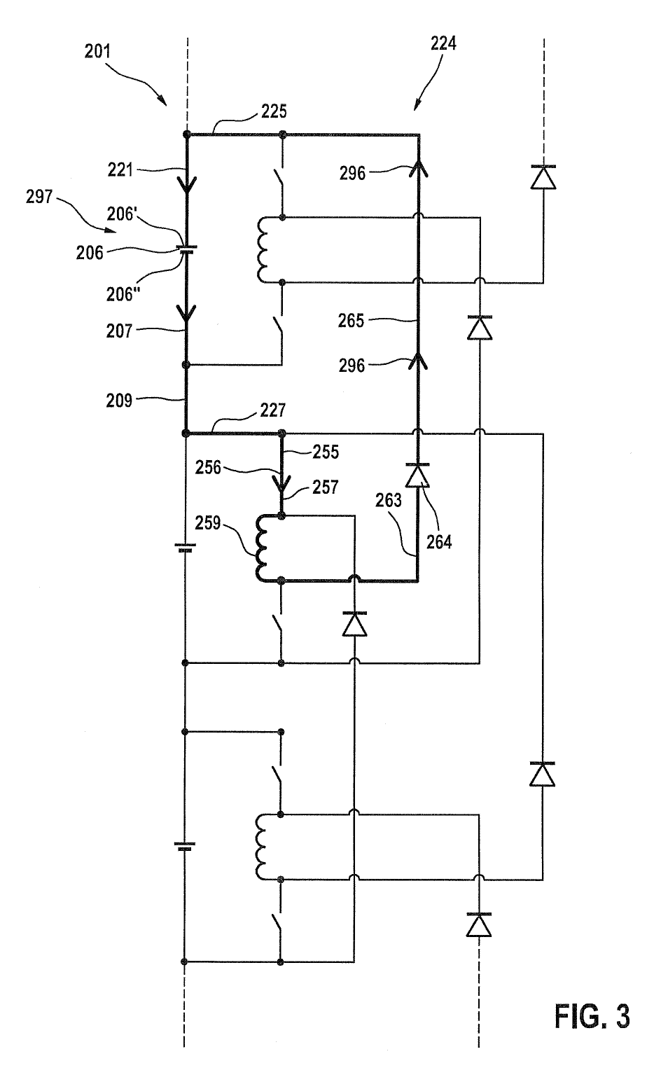

FIG. 3 shows the accumulator with the balancing circuit of FIG. 1 in a second method step; and

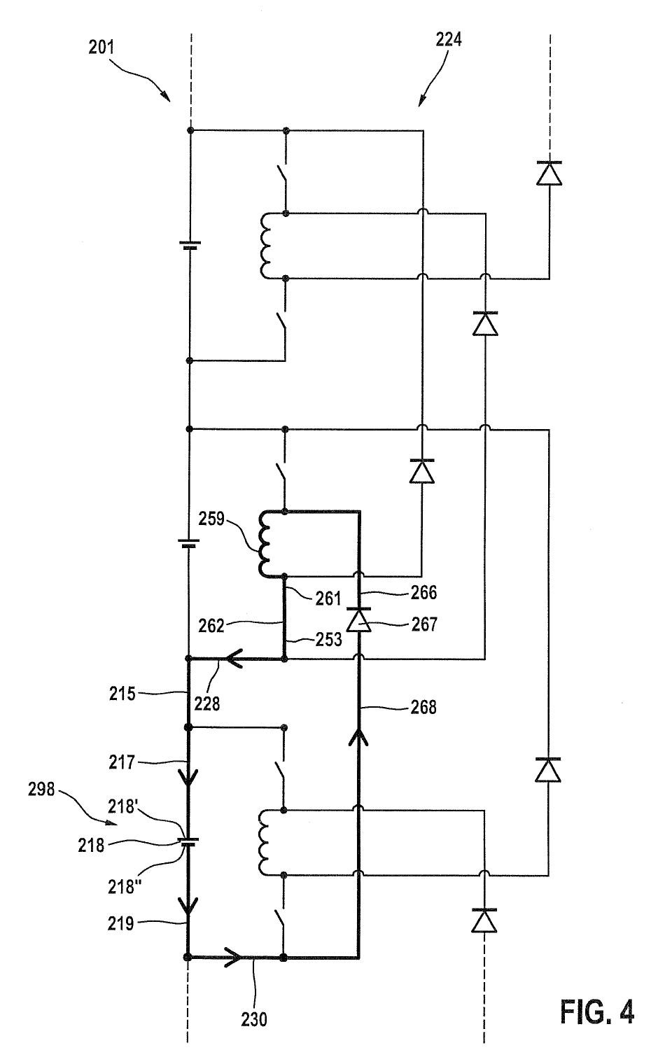

FIG. 4 shows the accumulator with the balancing circuit of FIG. 1 in a further, second method step.

FIG. 1 shows a detail of an electrical accumulator 201, comprising three accumulator units 202 connected in series. The individual accumulator units 202 are embodied as accumulator cells 203. The electrical accumulator 201 is embodied as a battery 204, and as a result the accumulator cells 203 are embodied as battery cells 205. A first accumulator unit 206 is connected via a negative pole 206″ to a line 207, which leads to a node point 208, which is connected by means of a line 209 to a further node point 210. The node point 210 is connected by means of a line 211 to the accumulator unit 212. The second accumulator unit 212 has a positive pole 212′ and a negative pole 212″. The positive pole 212′ is connected to the line 211. The negative pole 212″ is connected via a line 218 having a node point 214 to a line 215, which leads to a further node point 216. From the node point 216, a further line 217 leads to a third accumulator unit 218. The accumulator unit 218 in turn has a positive pole 218′ and a negative pole 218″; the positive pole 218′ is connected to the line 217. From the negative pole 218″, a line 219 leads to a node point 220. The first accumulator unit 206 also has a positive pole 206′, which is connected via a line 221 to a node point 222. The result is thus a series circuit of adjacent accumulator cells 203 between the node points 220 and 222, which are not concluding node points 220 and 222 but rather can be logically continued in the manner shown, as indicated by the lines 223 drawn in dashed lines. The electrical accumulator 201 is assigned a balancing circuit 224, which is electrically connected by means of a line 225 to the node point 222, by means of the line 226 to the node point 208, by means of the line 227 to the node point 210, by means of the line 228 to the node point 214, by means of the line 229 to the node point 216, and by means of the line 230 to the node point 222. The balancing circuit 224, a detail of which is shown in FIG. 1, has coils 231, diodes 232 and switches 233. The balancing circuit 224 is embodied such that each accumulator unit 202 is assigned one coil 231. It is also assigned two switches 233 and two diodes 232. The line 225 ends at a node point 234, which extends via a line 235 to a first switch 236. From the switch 236, a line 237 extends to a node point 238, which is connected to a first coil 239. The coil 239 is connected to a further node point 240, which is connected via a line 241 to a second switch 242, which in turn is connected to the line 226. From the node point 240, a further line 243 extends to a first diode 244, which on the other side is connected to the dashed line 245, which indicates that the balancing circuit 224 can logically be continued at that point. The conducting direction of the diode 244 is oriented from the line 243 to the line 245. From the node point 238, a line 246 extends to a second diode 247, which is connected via a line 248 to a node point 249, which leads to the line 228. The diode 247 is oriented such that its conducting direction extends from the line 248 to the line 246. The line 227 ends at a node point 254, which extends via a line 255 to a third switch 256. From the switch 256, a line 257 extends to a node point 258, which is connected to a second coil 259. The coil 259 is connected to a further node point 260, which is connected via a line 241 to a further switch 262, which in turn is connected by the line 253 to the node point 249. From the node point 260, a further line 263 extends to a third diode 264, which on its other side is connected to a line 264 that extends to the node point 234. The conducting direction of the diode 264 is oriented from the line 263 to the line 265. From the node point 258, a line 266 extends to a fourth diode 267, which is connected via a line 268 to a node point 269 that least to the line 230. The diode 267 is oriented such that its conducting direction extends from the line 268 to the line 266. The line 229 ends at a node point 274, which extends via a line 275 to a fifth switch 276. From the switch 276, a line 277 extends to a node point 278, which is connected to a third coil 279. The coil 279 is connected to a further node point 280, which is connected via a line 281 to a sixth switch 282, which in turn is connected to the line 273 that leads to the node point 269. From the node point 280, a further line 283 extends to a fifth diode 284, which on its other side is connected to a line 285, which extends to the node point 254. The conducting direction of the diode 284 is oriented from the line 283 to the line 285. From the node point 278, a line 286 extends to a sixth diode 287, which can be continued via a dashed line 288. The diode 287 is oriented such that its conducting direction extends from the line 288 to the line 286. For the further course of the balancing circuit 224 a line that is connected to the line 226 and a line that is connected to the node point 274 must be taken into account as well. These two additional lines are not shown in FIG. 1 for the sake of simplicity. It is also provided that the balancing circuit 224 is assigned to a control unit, not shown, and that the switches 233 are embodied as semiconductor switches 291 in the form of transistors 292.

FIG. 2 shows the electrical accumulator 201 of FIG. 1 and the balancing circuit 224 of FIG. 1 with all their features. Unlike in FIG. 1, the accumulator unit 212 has a higher voltage than the other accumulator units 206 and 218; in addition, the switch 256 and the switch 262 are closed for a first method step, so that an electric circuit 295 is formed. The electric circuit 245 in FIG. 2 is shown in heavy lines and is provided with current direction arrows 296. The electric circuit 295 begins at the second accumulator unit 212 and extends from the positive pole 212′ via the lines 211, 227, 255 and 257 to the second coil 295. The second coil 259 is excited and the electric circuit 195 extends onward from the second coil 259 via the lines 261, 253, 228 and 213 to the negative pole 112″. It is provided that in this way, the second coil 259 is excited by means of the second accumulator unit 212, if the second accumulator unit 212 has a higher charge and hence a higher voltage than the other accumulator units 206 and 218. After a certain period of time or after a certain level of the current is exceeded, it is provided that one of the switches 256 or 262 be opened. Opening one of the two switches 256 or 262 creates different new electric circuits in each case, which are explained in the following drawing figures.

FIG. 3 shows the electrical accumulator 201 and the balancing circuit 224 of FIG. 1 with all their features. Unlike in FIG. 1, the switch 256 is closed and excites the second coil 259 for a second method step. Since the coil 259 is not excited further, the result is an electric circuit 297, by way of which the second coil 259 can be de-excited because it charges the electrical accumulator unit 206. The electric circuit 297 in FIG. 3 is shown in heavy lines and is provided with current direction arrows 296. Thus from the second coil 259, the electric circuit 297 extends via the line 263 to the third diode 264 and from the third diode 264 via the lines 265, 225 and 221 to the positive pole 206′ of the first accumulator unit 206. From the negative pole 206″ of the first accumulator unit 206, the electric circuit 297 is closed via the lines 207, 209, 227, 256 and 258 back to the second coil 259.

FIG. 4 shows the electrical accumulator 201 and the balancing circuit 224 of FIG. 1 with all their features. Unlike FIG. 1, the fourth switch 262 is closed and excites the second coil 259 for a further second method step. Because of the de-excitation of the second coil 259, the result is a electric circuit 298, which enables de-excitation of the coil 259 because the coil 259 charges the third accumulator unit 218. The electric circuit 298 in FIG. 4 is shown in heavy lines and is provided with current direction arrows 296. Thus from the second coil 259, the electric circuit 298 extends via the lines 261, 253, 228, 215 and 217 to the third accumulator unit 218. From the third accumulator unit 218, the electric circuit 298 extends onward via the lines 219, 230 and 268 to the fourth diode 267. From the diode 267, the electric circuit 298 is closed by means of the line 266 to the coil 259.

The method steps shown in FIGS. 2-4 describe the possibility of charging either the first accumulator unit 239 or the third second accumulator unit 279 with an electrical charge from the second accumulator unit 259. This process is highly energy-efficient, since no electrical consumers have to be used; instead, charges are transferred inside the accumulator units 202.

1-12. (canceled)

13. A method for balancing the electrical voltages of at least two serially connected electrical accumulator units, comprising the steps of:
charging a coil by means of a first accumulator unit; and
charging a second accumulator unit with the energy of the charged coil, and selectively only the second accumulator unit is charged.

14. The method as defined by claim 13, wherein as the first and second accumulator units are located adjacent one another.

15. The method as defined by claim 13, wherein by means of the accumulator unit having a higher voltage, the coil is charged.

16. The method as defined by claim 14, wherein by means of the accumulator unit having a higher voltage, the coil is charged.

17. The method as defined by claim 13, wherein as the accumulator units, one accumulator cell each, in particular a battery cell, is used.

18. The method as defined by claim 16, wherein as the accumulator units, one accumulator cell each, in particular a battery cell, is used.

19. The method as defined by claim 13, wherein the coil is charged by closure of a switch.

20. The method as defined by claim 14, wherein the coil is charged by closure of a switch.

21. The method as defined by claim 19, wherein the coil charges the second accumulator unit by opening the switch.

22. The method as defined by claim 20, wherein the coil charges the second accumulator unit by opening the switch.

23. The method as defined by claim 13, wherein the second accumulator unit is charged by the coil via at least one diode.

24. The method as defined by claim 19, wherein the second accumulator unit is charged by the coil via at least one diode.

25. The method as defined by claim 13, wherein a plurality of charged accumulator units and a plurality of switches are used, and that the charged coil, by an opening of at least one corresponding switch, charges at least one accumulator unit assigned to the switch.

26. The method as defined by claim 17, wherein a plurality of charged accumulator units and a plurality of switches are used, and that the charged coil, by an opening of at least one corresponding switch, charges at least one accumulator unit assigned to the switch.

27. An electrical accumulator having at least two serially connected electrical accumulator units and one electrical balancing circuit, in particular for performing the method as defined by claim 13, the balancing circuit having at least one coil for charging by means of a first accumulator unit and for charging a second accumulator unit, and selectively only the second accumulator unit is chargeable.

28. The accumulator as defined by claim 27, wherein the balancing circuit has at least one diode and/or at least one switch.

29. The accumulator as defined by claim 28, wherein the switch is embodied as a semiconductor switch, in particular a transistor or thyristor.

30. The accumulator as defined by claim 27, wherein each of the accumulator units has an accumulator cell, in particular a battery cell.

31. The accumulator as defined by claim 28, wherein each of the accumulator units has an accumulator cell, in particular a battery cell.

32. The accumulator as defined by claim 29, wherein each of the accumulator units has an accumulator cell, in particular a battery cell.
